(19) United States
(12) Patent Application Publication
(10) Pub. No.: US 2016/0203163 A1
(43) Pub. Date: Jul. 14, 2016

(54) MAP ANALYTICS FOR INTERACTIVE WEB-BASED MAPS

(71) Applicant: Sparkgeo Consulting Inc., Prince George (CA)

(72) Inventors: William Cadell, Prince George (CA); Dustin Sampson, Kamloops (CA)

(21) Appl. No.: 14/620,479

(22) Filed: Feb. 12, 2015

(30) Foreign Application Priority Data
Jan. 8, 2015 (CA) 2876953

(51) Int. Cl. G06F 17/30; H04L 29/08; G06F 3/0484

(52) U.S. Cl. CPC G06F 17/30241; G06F 3/0484; G06F 17/3089; H04L 67/02

(57) ABSTRACT

The present disclosure describes technology for capturing data pertaining to user activities on interactive web maps. The captured data can then be analyzed to provide developers with insight into the performance of those maps, measuring not only technical performance but also “cartographic” and/or “user experience” performance. The technology listens for and captures appropriate events occurring on instances of the web map for aggregation and analysis.

This application claims the benefit of Canadian Patent Application No. 2,876,953 filed Jan. 8, 2015, which is hereby incorporated by reference in its entirety.

### TECHNICAL FIELD

The present disclosure relates to mapping, and more particularly to analytics for interactive web-based maps.

### BACKGROUND

Web based mapping services allow interactive maps to be displayed in a Web browser. A Web browser (referred to herein simply as a “browser”) is a software program that can retrieve and present information on the World Wide Web in the form of web pages and typically can also run specialized programs written in a suitable scripting language such as JavaScript. Such programs are referred to herein as “browser-executable software programs”. Interactive maps can be embedded in a web page. For example, Google Inc., having an address at 1600 Amphitheatre Parkway, Mountain View, Calif. 94043 (U.S.A.) provides a web-based mapping service under the name “Google Maps”, and the Google Maps API (Application Programming Interface) allows a Google Maps map to be embedded into an external web site. Information on embedding a Google Maps map into an external website is provided at https://developers.google.com/maps/tutorials/fundamentals/adding-a-google-map, the teachings of which are hereby incorporated by reference. A business may use this functionality to embed in its web page an interactive map that shows the location of the business.

In many web map applications, a tile-based architecture is used. A map server will store a plurality of maps, with each map made up of a set of contiguous square sections referred to as “tiles”, typically representing 256 pixels by 256 pixels although other sizes may be used. Each tile may take the form of a static image, or may take the form of (for example) raster image data or vector image data. Each map has a specified zoom level, with higher zoom levels showing more detail and hence needing more tiles to cover a given region. Conventionally, zoom levels are incremented by powers of four. Thus, at zoom level zero (z0), a single tile (i.e. 4⁰=1) represents the entire earth, at zoom level one (z1), four tiles (i.e. 4¹=4) represent the entire earth, at zoom level two (z2), sixteen tiles (i.e. 4²=16) represent the entire earth, and so on. Tile based maps use a z/x/y coordinate system in which “z” specifies the zoom level and the “x” and “y” coordinates specify the position of the tile within a Cartesian grid for that zoom level.

While it is possible to manually select and position the necessary tiles to produce a desired map view, in practice a library, referred to as a map client, is used to automate this process. The map client, often written in JavaScript so that it can execute within the browser, can determine which tiles are needed to present a map of a particular region at a particular zoom level. Thus, a developer can provide the map client with the coordinates (latitude and longitude) on which to center the map and with the desired zoom level, and the map client can then determine the appropriate tiles.

While a tile-based web map may be displayed statically, it is common to enable a user to interact with the web map by panning (moving the map window relative to the presently displayed map) and zooming. In response to such user interaction, the map client may request the tiles needed to display the relevant portions of the map at the appropriate zoom level.

Some map clients permit additional features to be added to the displayed maps. For example, the Google Maps API allows site-specific information to be overlaid on the displayed map. One common example of an additional feature is to add clickable markers at particular locations on the displayed map to enable further interactivity. In one such implementation, clicking on a marker representing the location of a business may cause information about that business to be displayed in the browser.

While the ability to present interactive web maps has many advantages, the selected presentation may not be optimal. For example, a business website may include a web map where the initial zoom level is too great for a user to locate the business in relation to nearby landmarks within the city or town, or is insufficient for a user to be able to discern the identity of the street where the business is located. Similarly the web map may not be centered appropriately. In either case, the user may have to pan or zoom to obtain a desired view. This can be frustrating, especially since the user may pan or zoom too far, and have to use a trial and error process to obtain a more useful view. In some cases, the user may give up in frustration, and the business may even lose a customer.

### SUMMARY

The present disclosure describes technology for capturing data pertaining to user activities on interactive web maps. The captured data can then be analyzed to provide developers with insight into the performance of those maps, measuring not only technical performance but also “cartographic” and/or “user experience” performance. The technology listens for and captures appropriate events occurring on instances of the web map for aggregation and analysis.

In one aspect, a method for gathering map usage data on multiple instances of a map distributed over a network comprises, for each of at least one individual map object associated with a respective web page, with each individual map object also associated with a region of the Earth, receiving, at a first server, map interaction records for multiple instances of that map object. The map interaction records are received from a plurality of map listener instances, with each map listener instance being encapsulated in a respective web page instance executing in a browser on a respective client. Each respective web page instance presents the respective instance of the individual map object together with corresponding map data as an embedded interactive map covering at least the region of the Earth with which the individual map object is associated. The map interaction records record user interactions with the embedded interactive maps, and include, for at least some of the user interactions, cartographic relationships between those user interactions and the region of the Earth with which the individual map object is associated.

Preferably, the map interaction records record at least one of user panning of the respective interactive maps, user zooming of the respective interactive maps, map extents of the respective interactive maps, map center points of the respective interactive maps and user click locations on the respective interactive maps.

In one embodiment, each web page instance is served by the first server. In this embodiment, the map data may be served by a map server that is separate and distinct from the first server.

In another embodiment, each web page instance is served by a second server that is separate and distinct from the first server. In this embodiment, the map data may be served by a map server that is separate and distinct from the first server and is separate and distinct from the second server.

In some embodiments, the at least one individual map object associated with a respective web page is a plurality of individual map objects associated with a plurality of respective web pages. In such embodiments, the method may further comprise, for each individual map object, separately analyzing the map interaction records for each individual map object.

Each map listener instance may comprise browser-executable code.

In other aspects, data processing systems for implementing the methods, and computer program products comprising tangible computer readable media embodying instructions for implementing the methods, are provided.

### BRIEF DESCRIPTION OF THE DRAWINGS

These and other features will become more apparent from the following description in which reference is made to the appended drawings wherein:

FIG. 1A illustrates schematically a first exemplary implementation of a method for gathering map usage data on multiple instances of a map distributed over a network;

FIG. 1B illustrates schematically a second exemplary implementation of a method for gathering map usage data on multiple instances of a map distributed over a network;

FIG. 1C shows an arrangement in which map interaction records for a plurality of individual map objects, each associated with a different web page hosted by a different server, can be collected and analyzed at a common server;

FIG. 2 is a schematic block diagram showing an exemplary implementation of a map listener;

FIG. 3 is a schematic block diagram illustrating an exemplary implementation of a map data processing engine;

FIG. 4 is an exemplary visualization of exemplary analytic data showing, in graphical form, average load times for two map layers;

FIG. 5 is an exemplary visualization of exemplary analytic data showing, in graphical form, general loading and activity data for users of instances of a particular map object;

FIG. 6 is an exemplary visualization of exemplary analytic data showing, in graphical form, the frequency with which users act on areas of embedded interactive maps corresponding to particular locations on the Earth, presented by zoom level;

FIG. 7 shows HTML code for a simple web page after integration of code for a map listener for a Leaflet.js map;

FIG. 8 is a block diagram showing an illustrative computer system in respect of which the technology herein described may be implemented; and

FIG. 9 is a block diagram showing an illustrative networked mobile wireless telecommunication computing device in respect of which the technology herein described may be implemented.

### DETAILED DESCRIPTION

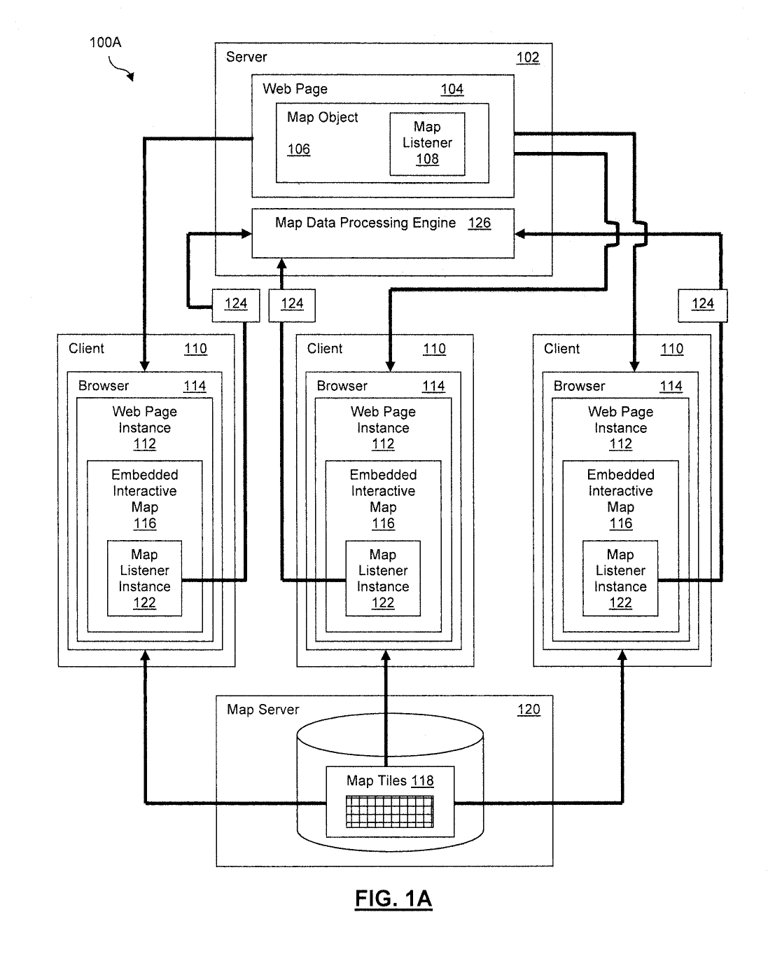

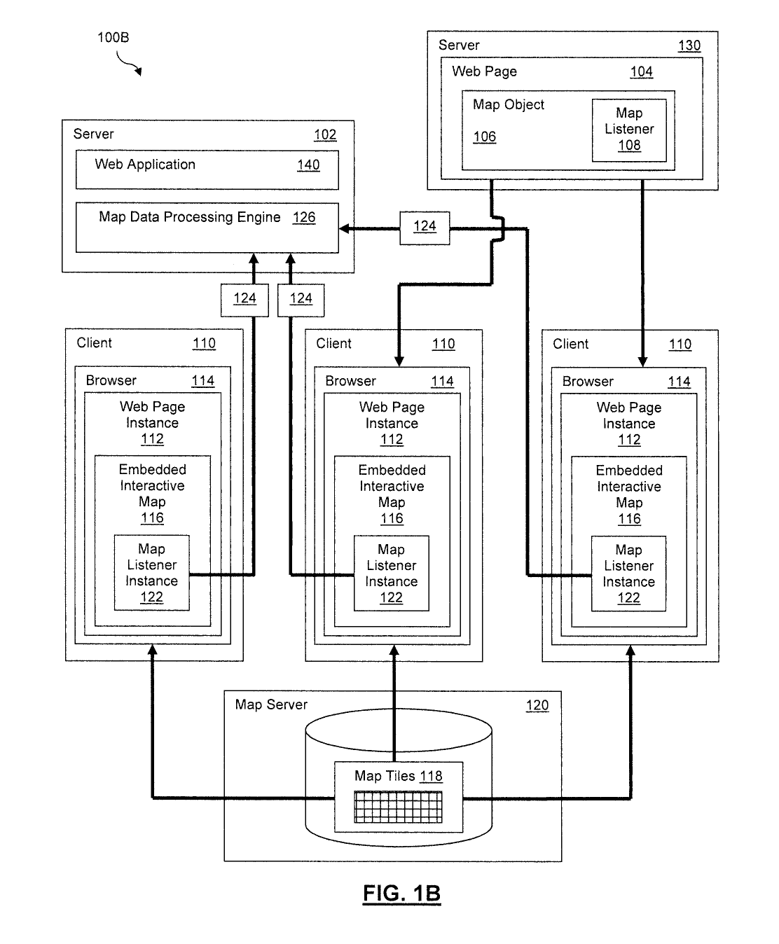

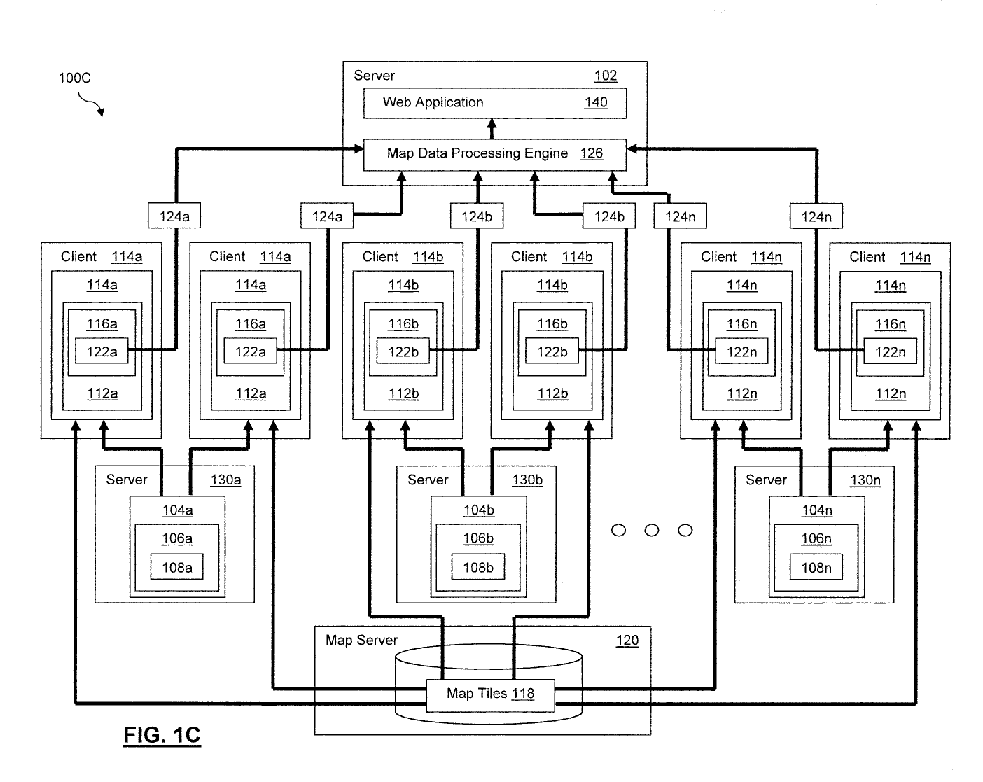

Reference is now made to FIG. 1A, which illustrates schematically a first exemplary implementation 100A of a method for gathering map usage data on multiple instances of a map distributed over a network, such as the Internet. Thus, although not shown in the Figures, one skilled in the art will appreciate that the various computers will typically be geographically remote from one another, and that communication among the various computers will typically be mediated by one or more networks, such as the Internet.

In the first exemplary implementation 100A, a first server 102 stores a master copy of a web page 104. It is to be understood that the term “server”, as used herein, encompasses not only a single computer acting as a server but also a plurality of computers, possibly geographically dispersed, together acting as a server. The web page 104 stored on the first server 102 includes a map object 106 associated with the web page 104 and representing a cartographic region of the Earth.

The term “map object”, as used herein, refers to a digital cartographic representation of all or part of the Earth and which enables a user to interact with the representation, such as by panning, zooming and/or clicking, and in which the representation has inbuilt cartographic context awareness. Any map will have a pictorial linkage to the represented region of the Earth in that the map is a visual representation of the region according to a cartographic convention. A “map object” provides, in addition to the pictorial linkage to the represented region, inbuilt cartographic context awareness in the form of a dynamic association between screen position in a map display generated from an instance of the map object and a corresponding cartographic coordinate representing a position on the Earth. Stated more colloquially, a map object “knows” the correspondence between pixel positions and real-world cartographic positions. For example, in the context of a tiled web map, the map object can determine the real-world cartographic coordinate corresponding to a particular pixel based on the tiles that are currently displayed, which are dictated by the general region and the zoom level, and the screen position of the displayed tiles. A map object, although initially centered on a particular coordinate at a particular zoom level, will typically cover the entire earth, although a map object may cover a smaller cartographic region. Thus, a map object will typically be associated with a particular region of the Earth, with that region being generally defined by the initial centering coordinate and the initial zoom level.

In a tiled web map application, a map object will typically not include copies of the tiles, but will comprise instructions for retrieving (e.g. from a map server) and displaying the appropriate tiles as well as additional instructions for supporting user interaction with the map. For example, a map object for a tiled web map application may include instructions for retrieving and displaying an initial set of tiles as well as instructions for retrieving and displaying additional tiles in response to user pan or zoom commands, and may also include instructions for retrieving additional information when a user clicks on particular areas of the map.

Map objects are designed so that an instance of the map object can execute on the client side of a client-server relationship. In a presently preferred embodiment, the map object 106 is coded in a browser-executable language such as JavaScript and, as shown in FIG. 1A, is included as part of the program code for the web page 104. The map object 106 is included in the web page 104 in such a way that an instance of the web page 104 displayed in a browser will include a corresponding instance of the map object for presenting an embedded interactive map. As such, an “instance” of a map object may be understood as being the client-side copy of the map object 106. The instance of the map object, together with the retrieved map data (e.g. tiles and any additional layers), are presented by the web page as an embedded interactive map covering the region of the Earth with which the map object is associated.

The web page 104 stored on the first server 102 encapsulates a map listener 108. The map listener 108 is a browser-executable software program for creating map interaction records, that is, records of how a user interacts with an embedded interactive map, and a map listener instance is an individual copy of a map listener. Thus, when an instance of the web page 104 is presented by a browser on a client computer, the associated map listener instance will execute within the browser to record the way the user interacts with the corresponding instance of the map object. The recorded user interactions will typically include at least one of user panning of the respective map (“pan events”), user zooming of the respective map (“zoom events”), map extents, map center points and user click locations on the respective map (“click events”). Since the map object and hence each instance thereof has inbuilt cartographic context awareness, the recorded interactions can be cartographically associated with the region of the Earth represented by the map object.

As shown in FIG. 1A, in a presently preferred embodiment, the map listener 108 is included with the browser-executable code for the map object 106. For example, in a presently preferred embodiment both the map object 106 and the map listener 108 are implemented in JavaScript. A different map listener (i.e. a different JavaScript library) will be provided for each type of map object to be supported. For example, present map object formats include Google Maps API, LeafletJS, Openlayers3, Bing Maps and ESRI.js and a map listener can be provided for each; a map listener may be developed for any suitable map object format. Suitable map listeners for each type of supported map object can be hosted on a content delivery network along with guidance to assist developers in selecting the appropriate map listener for the type of map object that they wish to monitor.

In the first exemplary implementation 100A, a plurality of client computers 110 have requested the web page 104 from the first server 102, and the first server 102 has served an instance (copy) 112 of the web page 104 to each client computer 110. Thus, each client computer 110 has a web page instance 112 executing within a browser 114 running on the respective client computer 110. Each web page instance 112 presents a respective instance of an individual map object, that is, an instance of the map object 106, together with corresponding map data, as an embedded interactive map 116. More particularly, each instance of the map object 106 requests the appropriate tiles 118 from a map server 120, and then displays the served tiles in the respective embedded interactive map 116. In the illustrated embodiment, the map server 120 is separate and distinct from the first server 102.

Each web page instance 112 encapsulates a map listener instance 122 executing within the browser 114 on the respective client computer 110. Each map listener instance 122 records user interactions with the respective embedded interactive map 116 in the web page 106 and thereby generates map interaction records 124 for that client computer 110.

In the first exemplary implementation 100A shown in FIG. 1A, the map listener instances 122 transmit the map interaction records 124 for the embedded interactive maps 116 to a map data processing engine 126 on the first server 102, which receives the map interaction records 124 from the map listener instances 122 for further processing as described below. Thus, in FIG. 1A, the map data processing engine 126 is located on the same server 102 that serves the instances 112 of the web page 104 to each client computer 110. The implementation 100A shown in FIG. 1A represents a case where a developer manages gathering and analysis of the map usage data directly by installing the map data processing engine 126 on the server 102 that the developer uses to host the web page 104. The term “developer”, as used herein, refers to those who implement and/or manage web pages that present interactive maps (i.e. the web page 106 shown in FIG. 1A).

Reference is now made to FIG. 1B. FIG. 1B is a schematic illustration of a second exemplary implementation 100B of a method for gathering map usage data on multiple instances of a map distributed over a network such as the Internet. The second exemplary implementation 100B shown in FIG. 1B is similar to the first exemplary implementation 100A shown in FIG. 1A, with like references denoting like features. The second exemplary implementation 100B shown in FIG. 1B differs from the first exemplary implementation 100A shown in FIG. 1A in that in the second exemplary implementation 100B shown in FIG. 1B, the web page 104 that encapsulates the map listener 108 is stored on, and instances 112 of the web page 104 are served by, a second server 130 that is separate and distinct from the first server 102. In the illustrated embodiment, the map server 120 is separate and distinct from both the first server 102 and the second server 130. Thus, the map data processing engine 126 resides on the first server 102 and the web page 104 resides on the second server 130. The implementation 100B shown in FIG. 1B may be used as an architecture preference where a developer manages gathering and analysis of the map usage data directly and controls both the first server 102 and the second server 130. The implementation 100B shown in FIG. 1B may also be used where gathering and analysis of the map usage data is provided as a web-based service by a third party relative to the developer of the web page 104.

More particularly, the implementation 100B shown in FIG. 1B facilitates an arrangement in which map interaction records for a plurality of individual map objects, each associated with a different web page hosted by a different server, can be collected and analyzed at a common server. Thus, as shown in FIG. 1C, the map data processing engine 126 resides on a first server 102, and servers 130a . . . 130n host respective web pages 104a . . . 104n each including a respective map object 106a . . . 106n and encapsulating a respective map listener 108a . . . 108n. Thus, there are a plurality of individual map objects 106a . . . 106n associated with a plurality of respective web pages web pages 104a . . . 104n. Respective instances 112a . . . 112n of the web pages 104a . . . 104n are served to respective client computers 110a . . . 110n, and the map listener instances 122a . . . 122n executing within the browsers 114a . . . 114n on the respective client computer 110a . . . 110n transmit respective map interaction records 124a . . . 124n to the data processing engine 126 on the common first server 102. The common first server 102 also hosts a web application 140, as will be described further below. Although only a single map server 120 is shown in FIG. 1C for simplicity of illustration, it will be appreciated that the map data for the embedded interactive maps 116a . . . 116n may come from a plurality of distinct map servers (e.g. if different types of map objects are used).

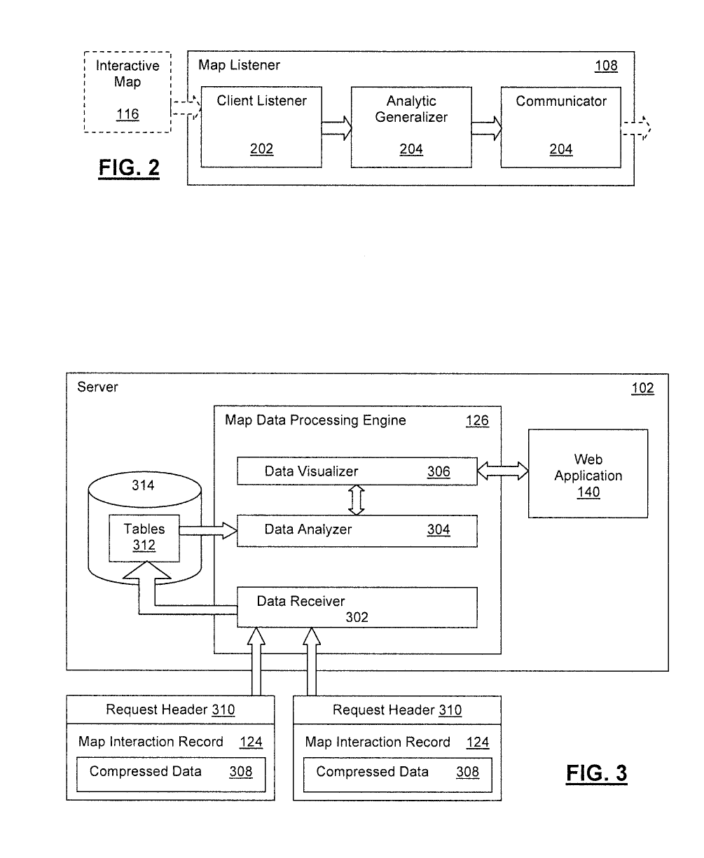

Reference is now made to FIG. 2, which shows in schematic form an exemplary implementation of a map listener 108. The exemplary map listener 108 comprises a client listener 202, an analytic generalizer 204 and a communicator 206.

In the exemplary embodiment, the client listener 202 is a browser-executable software program; each instance of the client listener 202 interacts directly with the instance of the map object being monitored, that is, with the embedded interactive map 116 in the web page 106 (FIGS. 1A to 1C). The particular implementation of the client listener 202 will depend on the format of the type of map object for which interactions are to be monitored but in each case the client listener 202 monitors (“listens”) for and captures particular events that occur on the instance of the map object. These events include, but are not limited to, pan events, zoom events and click events.

Because each interactive map 116 is an instance of a map object which has inbuilt cartographic context awareness, at least some of the events captured are cartographically associated with the region of the Earth represented by that map object. More particularly, not only the event, but also the cartographic location of the event with respect to the interactive map 116, can be captured by way of the dynamic association between the screen position in the interactive map 116 and the corresponding real-world cartographic coordinate. This allows the analysis of user interaction with the maps to include a “cartographic” perspective by considering events that are not captured by traditional web analytics; these events are intrinsic to the performance of the map and how its users interact with it.

In an exemplary embodiment, the client listener 202 uses a tracker prototype object to construct records of the events being monitored. An exemplary implementation of the tracker prototype object contains the following data attributes (with a description/explanation of each data attribute included in parentheses):
track_id (to identify each web domain)
Center (cartographic center of the event)
Zoom (the zoom level of the event)
map_sa_id (to identify each map within a domain)
sa_id (to identify a layer within a map)
Action (the type of activity)
Category (category of analytic)
Label (a label associated with a generic analytic capture)
Value (the value of a generic analytic)
Tilecenter (cartographic center of a tile)
Tileurl (URL of a specific tile image, if necessary)
map_session_id (to reference the session of the map)
layer_session_id (to reference the session of the layer)
Timestamp (time at which event occurred)

In the exemplary embodiment, for each event, the instance of the client listener 202 will capture the pertinent timestamps to enable a better understanding of the duration of events and thus of technical performance issues; implied from these events are concepts such as tile loading durations and error tiles. These events are tied back to particular map objects through the use of the common “track_id”, which identifies the web domain of a map object and the “sa_id” which identifies a particular map object managed under the web domain identified by the “track_id”. In the illustrated embodiment, the “track_id” is programmatically generated by the first server 102, for example by the web application 140, and the “sa_id” is generated by the developer. The timestamps also enable developers to see the number of users and the type of user interactions with the interactive web maps at various time intervals.

In the exemplary embodiment, the data attribute “Action” can be assigned a value of “Layerload”, indicating that the data record contains layer loading data, a value of “Mapactivity”, indicating that the data record contains map activity data, a value of “Tileerror”, indicating that the data record contains data about tile loading errors, or a value of “Statechange”, indicating that the data record contains data about a layer session state change (adding or removing a map layer). Also in the exemplary embodiment, the data attribute “Category” can be assigned a value of “Map”, indicating that the data record is for a map-based analytic, a value of “Tlayer”, indicating that the data record is for a tile layer analytic, or a value of “Layersession”, indicating that the data record is for a layer session-based analytic.

In one implementation, the client listener 202 binds to the map object and monitors activities within that map object. Binding enables the client listener 202 to add the “track_id” and “sa_id” to a particular event or object for tracking purposes.

As noted above, a different map listener 108 will be provided for each type of map object to be supported, and the client listener 202 will be adapted to a specific map object type. In order to simplify the map analytics, and to facilitate comparisons across different types of map object, it is preferable for the map interaction records to have a common data format, rather than having a different data format for each type of supported map object. The analytic generalizer 204 receives the data captured by the client listener 202 and translates that data into a common generic format that can be ingested by the processing engine that performs the map analytics (e.g. data analyzer 304 discussed below); the analytic generalizer 204 thus functions as a generalization layer. In a preferred embodiment, since the analytic generalizer 204 is part of the map listener 108, instances of the analytic generalizer 204 (each part of an instance of the map listener 108) will execute on the client computers 110, thereby reducing bandwidth consumption. In other embodiments, generalization may be provided on the server side.

The communicator 206 receives the generalized data from the analytic generalizer 204, prepares it, and then sends it to a server-side processing engine (e.g. the map data processing engine 126 on the first server 102) as a map interaction record. In a preferred embodiment, preparation of the generalized data includes compression to reduce the payload of the data sent the data receiver 302 (FIG. 3), thereby reducing the client-side bandwidth requirement; any suitable compression algorithm may be used. The communicator 206 is preferably configured to capture the IP address and device data for the respective client computers 110, 110a . . . 110n and includes this information in the request headers with the map interaction record 124, 124a . . . 124n (FIGS. 1A to 1C). In the preferred embodiment, the captured device data includes “browser family”, “browser version”, “operating system family”, “operating system version”, “device family”, “is_mobile”, “is_tablet”, “is_desktop”, “is_touch_capable” and “is_bot”.

Reference is now made to FIG. 3, which is a schematic block diagram illustrating in more detail an exemplary implementation of a map data processing engine 126 (which was shown as a single block in FIGS. 1A to 1C). The map data processing engine 126 comprises a data receiver 302, a data analyzer 304 and a data visualizer 306. In one embodiment, the map data processing engine 126 may be written in the Python™ programming language and deployed on a scalable Amazon™ Web Services platform.

In the exemplary embodiment, the data receiver 302 functions as a traffic controller, and receives map interaction records 124 from the map listeners 108 (FIGS. 1A to 1C). The data receiver 302 unpacks the compressed data 308 in the map interaction records 124, as well as the data in the request headers 310 (containing the IP address and device data), and then validates the received data and distributes the data to the relevant tables 312 in the data store 314. The data analyzer 304 accesses the tables 312 in the data store 314 to take the stored data as input to functions that apply the analytic logic and passes the results to the data visualizer 306, and the data visualizer 306 presents the results of the analytic functions carried out by data analyzer 304. In a preferred embodiment, the data analyzer 304 and the data visualizer 306 communicate with the web application 140 to receive requests from, and present the results of analytic functions to, developers. The use of a web application can facilitate other functions such as onboarding of new developers, management of developer accounts (including account settings), map setup and map management, as described further below.

The data visualizer 306 receives a request and then parses the request and provides instructions to the data analyzer 304 to execute the appropriate logic to generate the analytics specified by the request, after which the data analyzer 304 returns the results to the data visualizer 306 for formatting and presentation to the developer. In other embodiments the request may be passed directly to the data analyzer 304.

Each map interaction record 124 is associated with an instance of an individual map object, and hence each map interaction record 124 is associated with that single map object. This enables the analytics to be applied to each map object 106 individually. Accordingly, where there are a plurality of individual map objects 106a . . . 106n associated with a plurality of respective web pages 104a . . . 104n, as shown in FIG. 1C, the map interaction records 124a . . . 124n can be analyzed separately for each individual map object 106a . . . 106n so as to produce meaningful results for the developer of the web page 104a . . . 104n with which a particular map object 106a . . . 106n is associated. Aggregated analysis of multiple map objects 106a . . . 106n to obtain broader metrics is also contemplated.

In a preferred embodiment, the analytics performed by the data analyzer 304 and presented by the data visualizer 306 can be broadly characterized as falling in one of two general categories: technical performance analytics and user analytics.

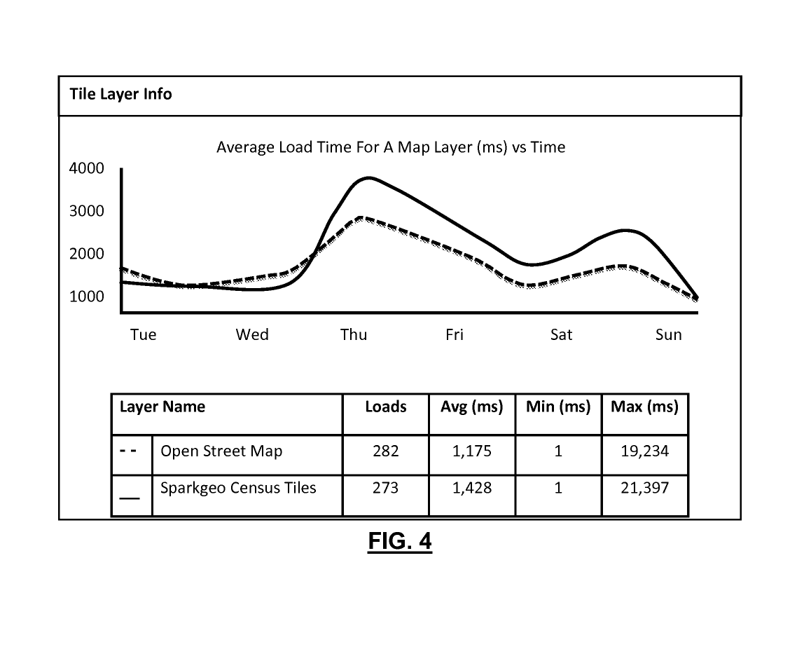

The technical performance analytics pertain mainly to the loading speed of key cartographic elements like map tiles. FIG. 4 is an exemplary visualization of exemplary analytic data showing, in graphical form, average load times for two map layers. In addition to loading speeds, the data analyzer 304 can also be configured to indicate the presence of any error tiles, and can report the cartographic location of those erroneous tiles. Performance can be assessed at the level of individual tiles, and this information can be applied toward improving the map serving environment.

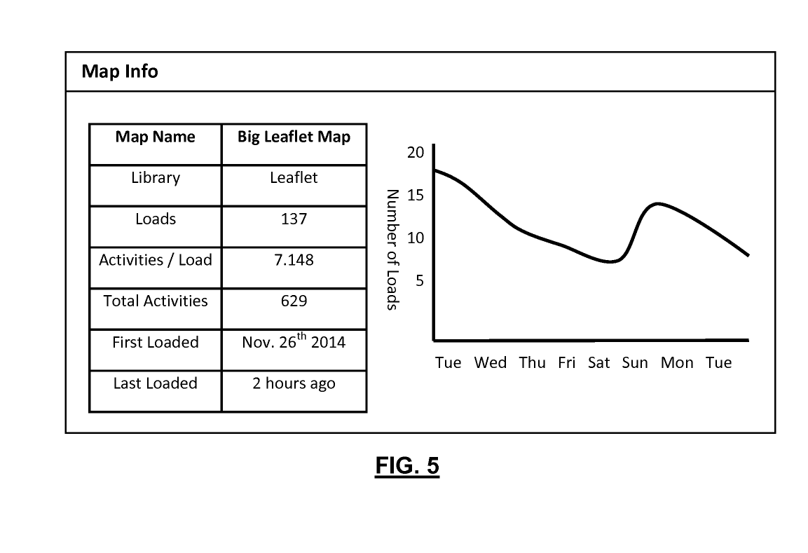

The user analytics involve analysis of user data, that is, data about how the users interact with the embedded interactive maps 116. Some of the user data may be cartographically agnostic. For example, FIG. 5 is an exemplary visualization of exemplary analytic data showing, in graphical form, general loading and activity data for users of instances of a particular map object. The data shown in FIG. 5 includes the number of times an individual map (as identified by the combination of “track_id” and “sa_id”) is loaded, the average number of user interactions (activities) per load, the total number of user interactions, and the times of the earliest and most recent loads. The data shown in FIG. 5 is cartographically agnostic because, aside from the identity of the map object itself (which is associated with a region of the Earth), the user interactions represented by that data do not have any particular cartographic relationship with the region of the Earth with which the particular map object is associated.

Importantly, the user analytics can also include cartographic information because the map interaction records 124 include, for at least some of the captured user interactions, cartographic relationships between those user interactions and the region of the Earth with which the particular map object is associated. This is made possible by the dynamic association between screen position in a map display generated from an instance of the map object and a corresponding cartographic coordinate representing a position on the Earth: screen positions correspond to positions on the map, which in turn correspond to coordinates on the Earth.

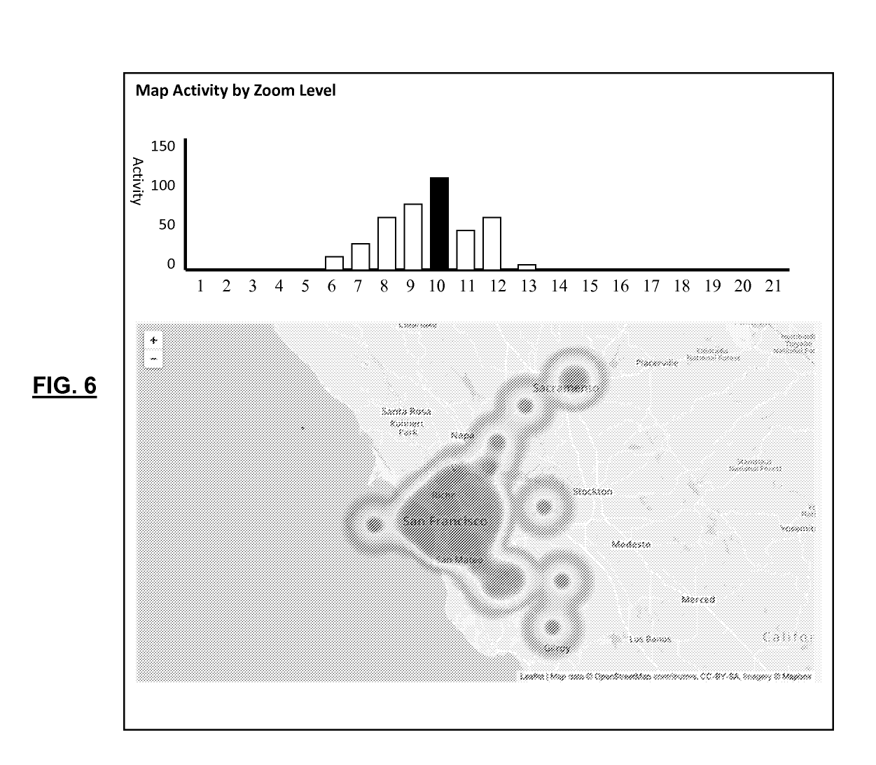

The cartographic relationships between user interactions and the region of the Earth with which a map object is associated can take a variety of forms. For example, the cartographic coordinates of users' activities on the embedded interactive maps can be recorded; a user's interest in a particular part of a map may correlate with an interest in the corresponding region of the Earth. Recording the cartographic coordinates of users' activities on the embedded interactive maps is different from merely recording the screen positions of a user's interactions with a web page because in the context of an interactive map, the same screen position will correspond to different cartographic coordinates depending on the zoom level and pan position of the embedded interactive map. FIG. 6 is an exemplary visualization of exemplary analytic data showing, in graphical form, the frequency with which users act on areas of embedded interactive maps corresponding to particular locations on the Earth, presented by zoom level. The visualization shown in FIG. 6 is presented in the form of a “heatmap” but any magnitude-based visualization would be suitable to indicate how users interact with some geographic areas of a map significantly more than with other geographic areas of the map even though the size and shape of the map in consideration of the webpage itself remains constant.

Another cartographic relationship between user interactions and the region of the Earth with which a map object is associated is the relationship between a user's actual position on the Earth and a cartographic coordinate represented by a the part(s) of the embedded interactive map with which the user interacts. For example, a user's approximate physical location can be recorded in the map interaction record 124 (FIGS. 1A to 1C); this physical location is related to the center of the map region displayed by the embedded interactive map at any given time, and also to the position on the Earth corresponding to a click location on the embedded interactive map. These relationships can be used to create a “map vector” in which the direction is measured from the bearing between the approximate physical location of the user(s) and the location on the map with which the user is interacting and the magnitude is the number of users interacting along that same bearing. The relationship between a user's actual position on the Earth and a cartographic coordinate represented by the part(s) of the embedded interactive map with which the user interacts can also be used to determine the average distance between users' locations and the relevant locations on the embedded interactive map.

Still further examples of cartographic relationships between user interactions and the region of the Earth with which a map object is associated include the cartographic relationships arising from the user interactions of panning, zooming and combinations of panning and zooming. The user interaction of panning on an embedded interactive map has a cartographic relationship with the region of the Earth with which the corresponding map object is associated because panning on the map correlates to moving from one physical location to another on the Earth. Similarly, the user interaction of zooming on an embedded interactive map has a cartographic relationship with the region of the Earth with which the corresponding map object is associated because zooming on the map is correlated to selecting larger or smaller regions of the Earth. Consistent panning actions by multiple users may indicate that the map object specifies a suboptimal initial center point for the interactive map, and consistent zooming actions by multiple users may indicate that the map object specifies a suboptimal initial zoom level for the interactive map. Consistent combinations of zooming and panning actions by multiple users may indicate that both the initial center point and the initial zoom level are suboptimal.

More generally, by determining the frequency and/or patterns of various user interactions with the embedded interactive maps, linkages between the user interactions and the user experience can be identified. For instance, a sudden zoom into a location followed by a sudden zoom out may indicate a user who misunderstands the control mechanism of the embedded interactive map. Thus, a specific sequence of particular user interactions can indicate a particular user experience, and a combination of particular map layers being loaded and particular user interactions being detected and recorded can indicate key user experience metrics. Visible layers can change how users interact with overlaid data layers, for instance users might click on markers more readily when they are overlaid on imagery rather than a cartographic fabric. Understanding how visible layers change a user's behavior can be used to improve the quality of a user's experience.

Analysis of user interactions, including initial user interactions and specific sequences of user interactions, together with their frequency, can be used to generate a “map score” representing the quality of interactive web maps, and hence the quality of the corresponding map object. The map score may be limited to usability factors, but preferably will also take into account technical performance analytics such as the response speeds of the tile-based data layers. In one embodiment, a generalized map performance matrix can be developed, and a particular interactive map/map object can be compared to that matrix to determine the map score. For example, a map performance matrix could include an expectation of average tile loading speed, or average activities per map load, and comparing the particular interactive map/map object in question to the map performance matrix would result in a “map score”.

As noted above, the implementation 100B shown in FIG. 1B facilitates an arrangement in which map interaction records for a plurality of individual map objects, each associated with a different web page hosted by a different server, can be collected and analyzed at a common server 102, as shown in FIG. 1C. As also noted above, the data visualizer 306 (FIG. 3) may be implemented in conjunction with a web application for use by developers, and such a web application can facilitate functions such as onboarding of new developers, management of developer accounts (including account settings), map setup and map management. Thus, in one embodiment, as shown in FIG. 1C, a web application 140 can be hosted on the common first server 102. Developers can use the web application 140 to create an account, and then add a site record comprising a name and a domain name. The web application 140 then creates a “track_id” identifier which is associated with that web domain. The developer can then access the appropriate JavaScript code for the map listener 108 that corresponds with the type of map object 106 being used in the developer's web page 104 and integrate the map listener 108 into the browser-executable code for the map object 106.

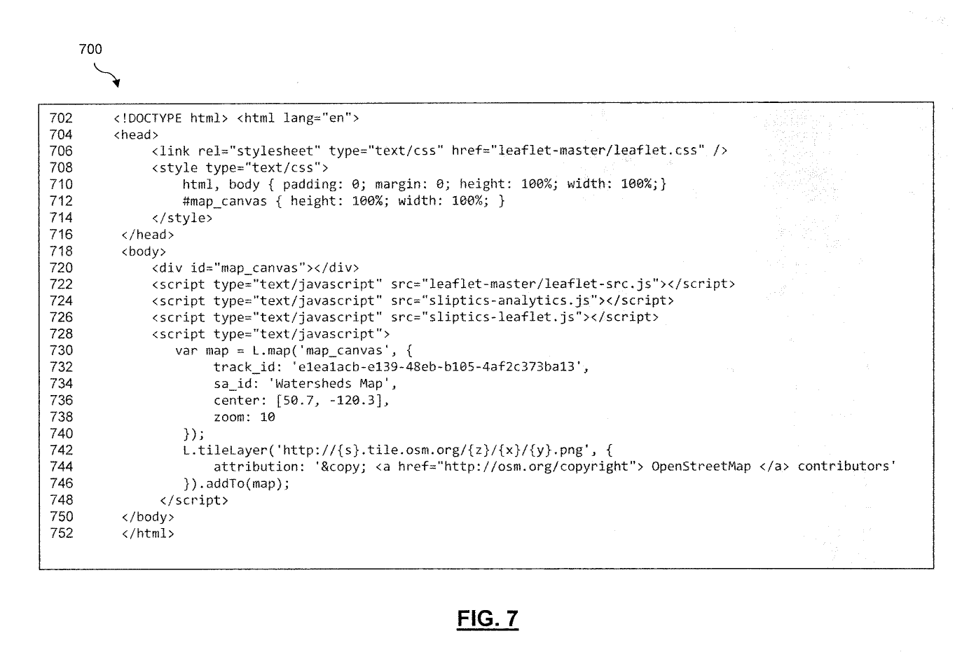

FIG. 7 shows the HTML code, indicated generally at reference 700, for a simple web page that includes an embedded Leaflet.js interactive map, after integration of code for a map listener for the Leaflet.js map. Lines 702 and 752 specify the document as an HTML document, and lines 706 to 716 contain the header for the HTML document; these are conventional and are not discussed further. Lines 718 to 750 contain the body of the HTML document. Line 720 contains a “div” element to position the embedded map in the web page, and lines 722 to 748 make up the map object. As noted above, in a presently preferred embodiment, the map listener 108 (FIGS. 1A to 2) is included in the browser-executable code for the map object 106.

Line 722 causes the browser to call and execute the JavaScript code for presenting and interacting with the map; this is conventional. Lines 724 and 726 cause the browser to call and execute the JavaScript code for the map listener 108. In particular, “sliptics-analytics.js” at line 724 is the general code, which is common for every instance of the map listener 108, and “sliptics-leaflet.js” at line 726 is the code that is specific to the Leaflet.js interactive web map library. Lines 728 and 748 specify that lines 730 to 746 are to be executed by the browser as JavaScript code. Lines 730 to 740 specify the details of the map to be displayed, and lines 742 to 746 cause the browser to retrieve tiles from the specified tile layer, in this case an OpenStreetMap tile layer. Lines 736 and 738 initialize the center of the map and the zoom level, respectively. Line 732 specifies the “track_id” value associated with the web domain, and line 734 specifies a “sa_id” value for the map (to differentiate that map from any other map attached to the same domain). In an embodiment, the individual map layers can also be differentiated, and the same method (“sa_id”) can be used for layer differentiation. In this embodiment, at the data store level the “sa_id”s referring to maps are identified as “map_sa_id” and the “sa_id”s referring to layers are identified simply as “sa_id” to avoid confusion. More than one map object be may be tracked for a single domain, for purposes of A/B testing to compare performance of different map objects, or simply because the domain includes more than one map object, for example a business web page may include a different map object for each location.

After the web page 104 has been modified to include the map listener 108, subsequently served instances 112 of the web page 104 will cause the respective browsers 114 to execute respective map listener instances 122, which will generate map interaction records 124 and transmit them to the map data processing engine 126. The developer will then be able to access the analytics via the web application 140.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to block diagrams of methods, apparatus (systems) and computer program products according to various embodiments. In this regard, the block diagrams in the Figures illustrate the architecture, functionality, and operation of possible implementations of systems, methods and computer program products according to various embodiments of the present technology. For instance, each block in the block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams, and combinations of blocks in the block diagrams, can be implemented by special purpose hardware-based systems that perform the specified functions or acts, or combinations of special purpose hardware and computer instructions.

It also will be understood that each block of the block diagrams, and combinations of blocks in the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram blocks.

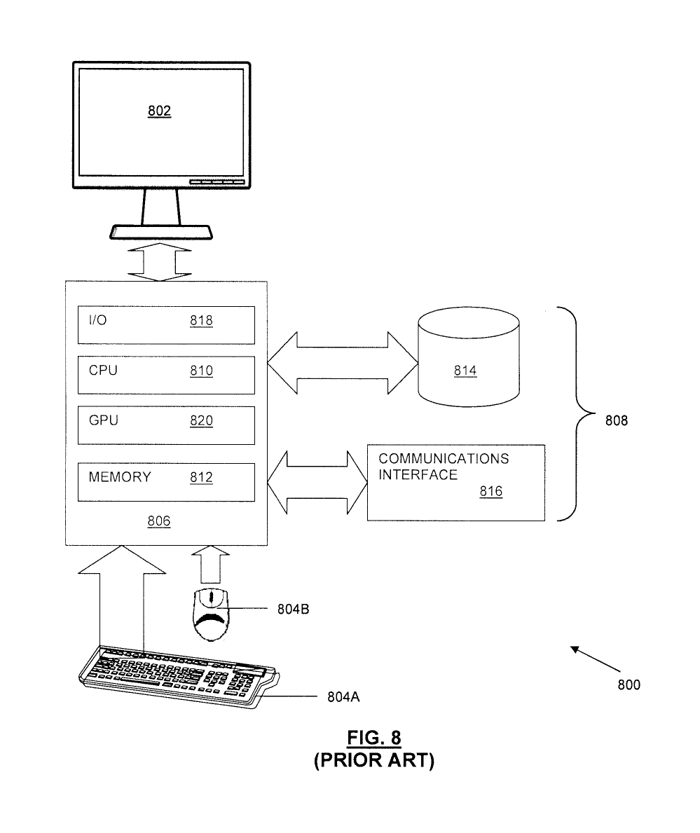

An illustrative computer system in respect of which the technology herein described may be implemented is presented as a block diagram in FIG. 8. The illustrative computer system is denoted generally by reference numeral 800 and includes a display 802, input devices in the form of keyboard 804A and pointing device 804B, computer 806 and external devices 808. While pointing device 804B is depicted as a mouse, it will be appreciated that other types of pointing device may also be used.

The computer 806 may contain one or more processors or microprocessors, such as a central processing unit (CPU) 810. The CPU 810 performs arithmetic calculations and control functions to execute software stored in an internal memory 812, preferably random access memory (RAM) and/or read only memory (ROM), and possibly additional memory 814. The additional memory 814 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 814 may be physically internal to the computer 806, or external as shown in FIG. 8, or both.

The computer system 800 may also include other similar means for allowing computer programs or other instructions to be loaded. Such means can include, for example, a communications interface 816 which allows software and data to be transferred between the computer system 800 and external systems and networks. Examples of communications interface 816 can include a modem, a network interface such as an Ethernet card, a wireless communication interface, or a serial or parallel communications port. Software and data transferred via communications interface 816 are in the form of signals which can be electronic, acoustic, electromagnetic, optical or other signals capable of being received by communications interface 816. Multiple interfaces, of course, can be provided on a single computer system 800.

Input and output to and from the computer 806 is administered by the input/output (I/O) interface 818. This I/O interface 818 administers control of the display 802, keyboard 804A, external devices 808 and other such components of the computer system 800. The computer 806 also includes a graphical processing unit (GPU) 820. The latter may also be used for computational purposes as an adjunct to, or instead of, the (CPU) 810, for mathematical calculations.

The various components of the computer system 800 are coupled to one another either directly or by coupling to suitable buses.

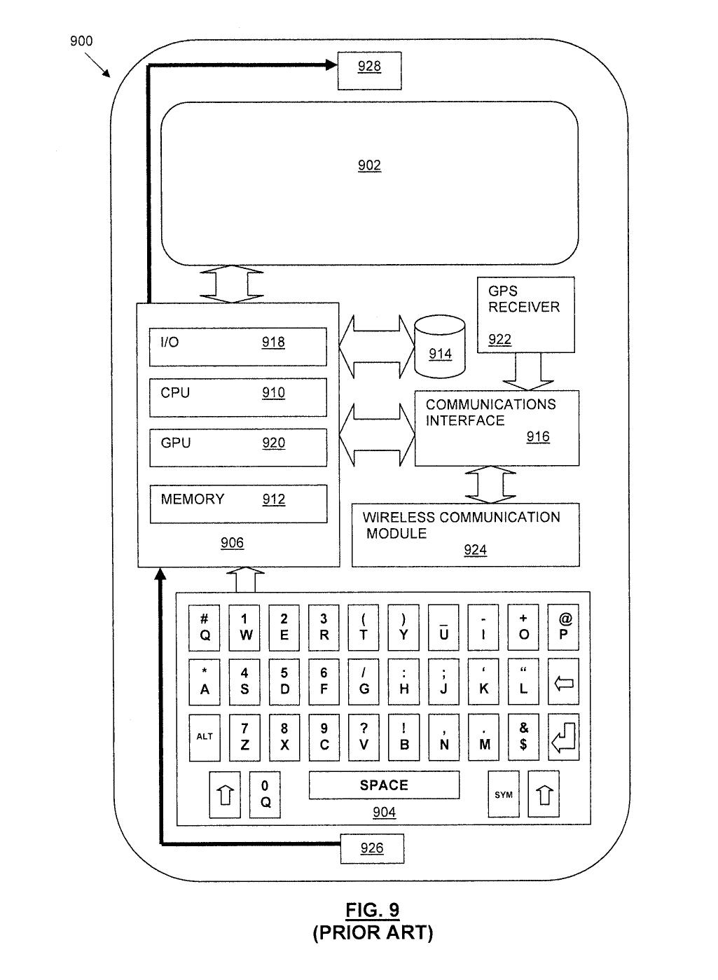

Aspects of the technology described herein can be applied to interactive web maps displayed on smartphones and similar devices. FIG. 9 shows an exemplary networked mobile wireless telecommunication computing device in the form of a smartphone 900. The smartphone 900 includes a display 902, an input device in the form of keyboard 904 and an onboard computer system 906. The display 902 may be a touchscreen display and thereby serve as an additional input device, or as an alternative to the keyboard 904. The onboard computer system 906 comprises a central processing unit (CPU) 910 having one or more processors or microprocessors for performing arithmetic calculations and control functions to execute software stored in an internal memory 912, preferably random access memory (RAM) and/or read only memory (ROM), coupled to additional memory 914 which will typically comprise flash memory, which may be integrated into the smartphone 900 or may comprise a removable flash card, or both. The smartphone 900 also includes a communications interface 916 which allows software and data to be transferred between the smartphone 900 and external systems and networks. The communications interface 916 is coupled to one or more wireless communication modules 924, which will typically comprise a wireless radio for connecting to one or more of a cellular network, a wireless digital network or a Wi-Fi network. The communications interface 916 will also typically enable a wired connection of the smartphone 900 to an external computer system. A microphone 926 and speaker 928 are coupled to the onboard computer system 906 to support the telephone functions managed by the onboard computer system 906, and GPS receiver hardware 922 may also be coupled to the communications interface 916 to support navigation operations by the onboard computer system 906. Input and output to and from the onboard computer system 906 is administered by the input/output (I/O) interface 918, which administers control of the display 902, keyboard 904, microphone 926 and speaker 928. The onboard computer system 906 may also include a separate graphical processing unit (GPU) 920. The various components are coupled to one another either directly or by coupling to suitable buses.

The term “computer system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 912 of the onboard computer system 906 of the smartphone 900 or the memory 812 of the computer 806, or on a computer usable or computer readable medium external to the onboard computer system 906 of the smartphone 900 or the computer 806, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

A number of embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method for gathering map usage data on multiple instances of a map distributed over a network, the method comprising:
for each of at least one individual map object associated with a respective web page, each individual map object also associated with a region of the Earth:
receiving, at a first server, map interaction records for multiple instances of that map object;
the map interaction records being received from a plurality of map listener instances;
each map listener instance being encapsulated in a respective web page instance executing in a browser on a respective client;
each respective web page instance presenting the respective instance of the individual map object together with corresponding map data as an embedded interactive map covering at least the region of the Earth with which the individual map object is associated;
the map interaction records recording user interactions with the embedded interactive maps;
the map interaction records including, for at least some of the user interactions, cartographic relationships between those user interactions and the region of the Earth with which the individual map object is associated.

2. The method of claim 1, wherein the map interaction records record at least one of user panning of the respective interactive maps, user zooming of the respective interactive maps, map extents of the respective interactive maps, map center points of the respective interactive maps and user click locations on the respective interactive maps.

3. The method of claim 1, wherein each web page instance is served by the first server.

4. The method of claim 4, wherein the map data is served by a map server that is separate and distinct from the first server.

5. The method of claim 1, wherein each web page instance is served by a second server that is separate and distinct from the first server.

6. The method of claim 5, wherein the map data is served by a map server that is separate and distinct from the first server and is separate and distinct from the second server.

7. The method of claim 1, wherein the at least one individual map object associated with a respective web page is a plurality of individual map objects associated with a plurality of respective web pages.

8. The method of claim 7, further comprising, for each individual map object, separately analyzing the map interaction records for each individual map object.

9. The method of claim 1, wherein each map listener instance comprises browser-executable code.

10. A server for gathering map usage data on multiple instances of a map distributed over a network, the server comprising:
at least one processor; and
a memory coupled to the at least one processor;
the memory containing instructions which, when executed by the at least one processor, cause the at least one processor to, for each of at least one individual map object associated with a respective web page, each individual map object also associated with a region of the Earth:
receive map interaction records for multiple instances of that map object;
the map interaction records being received from a plurality of map listener instances;
each map listener instance being encapsulated in a respective web page instance executing in a browser on a respective client;
each respective web page instance presenting the respective instance of the individual map object together with corresponding map data as an embedded interactive map covering at least the region of the Earth with which the individual map object is associated;
the map interaction records recording user interactions with the embedded interactive maps;
the map interaction records including, for at least some of the user interactions, cartographic relationships between those user interactions and the region of the Earth with which the individual map object is associated.

11. The server of claim 10, wherein the map interaction records record at least one of user panning of the respective interactive maps, user zooming of the respective interactive maps, map extents of the respective interactive maps, map center points of the respective interactive maps and user click locations on the respective interactive maps.

12. The server of claim 10, wherein the memory further contains instructions which, when executed by the at least one processor, result in the server serving each web page instance.

13. The server of claim 10, wherein the at least one individual map object associated with a respective web page is a plurality of individual map objects associated with a plurality of respective web pages.

14. The server of claim 13, wherein the memory further contains instructions which, when executed by the at least one processor, cause the at least one processor to separately analyze the map interaction records for each individual map object.

15. A computer program product comprising a tangible computer-readable medium embodying instructions which, when executed by at least one processor, cause the at least one processor to, for each of at least one individual map object associated with a respective web page, each individual map object also associated with a region of the Earth:
receive map interaction records for multiple instances of that map object;
the map interaction records being received from a plurality of map listener instances;
each map listener instance being encapsulated in a respective web page instance executing in a browser on a respective client;
each respective web page instance presenting the respective instance of the individual map object together with corresponding map data as an embedded interactive map covering at least the region of the Earth with which the individual map object is associated;
the map interaction records recording user interactions with the embedded interactive maps;
the map interaction records including, for at least some of the user interactions, cartographic relationships between those user interactions and the region of the Earth with which the individual map object is associated.

16. The computer program product of claim 15, wherein the map interaction records record at least one of user panning of the respective interactive maps, user zooming of the respective interactive maps, map extents of the respective interactive maps, map center points of the respective interactive maps and user click locations on the respective interactive maps.

17. The computer program product of claim 15, wherein the instructions, when executed by the at least one processor, result in the server serving each web page instance.

18. The computer program product of claim 15, wherein the at least one individual map object associated with a respective web page is a plurality of individual map objects associated with a plurality of respective web pages.

19. The computer program product of claim 18, wherein the instructions, when executed by the at least one processor, cause the at least one processor to separately analyze the map interaction records for each individual map object.
